(19) United States
(12) Patent Application Publication
(10) Pub. No.: US 2006/0038352 A1
(43) Pub. Date: Feb. 23, 2006

(54) Seal unit with integrated connection means and mechanical assembly using said seal unit

(76) Inventor: Stephane Gravier, Lyon (FR)

Correspondence Address: CLARK & BRODY, 1090 VERMONT AVENUE, NW, SUITE 250, WASHINGTON, DC, 20005, US

(21) Appl. No.: 11/179,053

(22) Filed: Jul. 12, 2005

(30) Foreign Application Priority Data
Jul. 16, 2004 (FR) 0407926

(51) Int. Cl. F16J 15/34

(52) U.S. Cl. 277/372

(57) ABSTRACT

The seal unit is intended to be interposed between two mechanical parts one mobile with respect to the other, the seal unit comprising a rigid body and at least one seal packing insert-moulded on the rigid body, so that the seal unit comprises at least one first sealing surface intended to cooperate with a first mechanical part and at least one second sealing surface intended to cooperate with the second mechanical part. According to the invention, the seal unit comprises connection means with at least one of the mechanical parts.

The present invention pertains to the technical area of seals and/or gaskets intended to be interposed between two mechanical parts, one mobile in relation to the other. In one preferred but not strictly necessary application, one of the parts may form the body of a hydraulic or pneumatic command mechanism inside which one or more aligned chambers are arranged within which a piston is in movement and forms the second part, mobile with respect to the first.

In some applications, it may be necessary to isolate or separate the two chambers in which the mobile part circulates and for this purpose it is known to use at least one seal unit comprising a rigid body and at least one seal packing insert-moulded on the rigid body, so that the seal unit comprises at least one static sealing surface intended to cooperate with a first metal part, such as the body of the aforementioned device for example, and one dynamic sealing surface intended to cooperate with a second part mobile with respect to the first, in this case the piston.

To ensure the proper positioning of the seal unit within the body and its immobilisation with respect to the body, it is known to use a blocking ring associated with an elastic ring intended to engage in a groove arranged in the body of the device. With said assembly it is effectively possible to guarantee the efficient sealing function of the unit, but it has the disadvantage however of using a large number of parts which increases production and assembly costs of the device and also increases risk factors for ill-functioning of the system, due either to poor assembly or to complete absence of one or more components of the seal assembly.

It is also known to mount the seal directly in a groove provided for this purpose. However, the positioning of the seal in said reduced space is likely to lead to early deterioration of the seal.

There is therefore an apparent need for a new type of seal unit whose use can reduce production costs and the risk of ill-functioning whilst providing similar even improved sealing properties compared with prior art seal units.

To achieve this objective, the invention concerns a seal unit to be interposed between two mechanical parts, one mobile with respect to the other, the seal unit comprising a rigid body and at least one seal packing insert-moulded on the rigid body, so that the seal unit comprises at least one first sealing surface intended to cooperate with a first mechanical part, and at least one second sealing surface intended to cooperate with the second mechanical part.

According to the invention, this seal unit is characterized in that it comprises connection means connecting with at least one of the mechanical parts.

Therefore, insofar as the seal unit incorporates the connection means needed for its immobilisation with respect to one of the two mechanical parts, it is possible to ensure a perfect seal function without any additional part for immobilising the seal unit. The design of the assembly integrating the two mechanical parts and the seal unit is therefore greatly simplified, leading to reduced production costs of the assembly and to reduced risks of defects which may occur when assembling the seal unit.

According to the invention, each of the sealing surfaces of the seal unit may be intended to ensure a dynamic or static seal, even static and dynamic.

It is to be noted that, in the meaning of the invention, the body of the seal unit is qualified as being rigid with respect to the flexibility or hardness of the seal packing. Therefore, it is to be considered that when a stress corresponding to normal conditions of use is applied to the seal unit of the invention, it is the seal packing which deforms initially whilst the rigid core substantially maintains its initial shape and dimensions. Evidently, it is also possible to use the seal unit of the invention by applying a stress to this seal unit which could also lead to deformation of the rigid body.

The body of the seal unit may be made in any appropriate material, such as a cast or machined metal for example, or a plastic material such as, but not exclusively, PPs, polyamides or semi-aromatic plastic materials.

The seal packing may be made in any suitable plastic material chosen for its deformation properties and resistance to the mechanical, thermal and chemical conditions of use of the seal unit. The seal packing may be in a plastic material such as HNBR or EPDM or a natural or synthetic polymer compatible with the fluids for which it is to ensure the seal.

According to the invention, the connection means may be made in any appropriate manner and are integral with the rigid body and/or seal packing.

According to one characteristic of the invention, the connection means comprise at least one connecting pin intended to engage in a complementary housing offered by the first mechanical part.

Preferably, but not strictly necessarily, the connecting pin is borne by at least one elastically deformable lug integral with the rigid body. The seal unit body and its insert-moulded packing may be of any shape. However, according to one preferred, but not strictly necessary characteristic of the invention, the body is of tubular shape and defines a through bore through which the second mechanical part passes, whilst the seal packing is of substantially annular shape.

According to one characteristic, the bore of the body then comprises at least one bearing surface for guiding the second mechanical part in translation and/or rotation.

According to another characteristic of the invention, the seal unit body comprises at least one static guiding surface intended to ensure the positioning of the seal unit with respect to the first mechanical part.

According to a further characteristic of the invention, when the through bore of the seal unit body comprises a guiding surface for the second mechanical part, the elastically deformable lug supporting the connecting pin is arranged at a recess made in the wall of the through bore of the body in order to avoid any direct contact between the elastic lug and the second mechanical part moving within the seal unit body.

The invention also concerns a mechanical assembly comprising two mechanical parts, one mobile with respect to the other, and a seal unit of the invention. The mechanical assembly is then characterized in that the first mechanical part comprises connection means intended to cooperate with the connection means of the seal unit.

According to a preferred but not strictly necessary characteristic of the invention, the first mechanical part of the mechanical assembly comprises a chamber inside which the second mechanical part is mobile in translation and/or rotation.

According to a further characteristic of the invention, the first mechanical part, as connection means with the seal unit, comprises an annular groove arranged in the wall of the chamber through which the second mechanical part passes.

Various other characteristics of the invention will become apparent from the description below given with reference to the appended drawings which illustrate different embodiments of the seal unit of the invention, and of a mechanical assembly incorporating said seal unit.

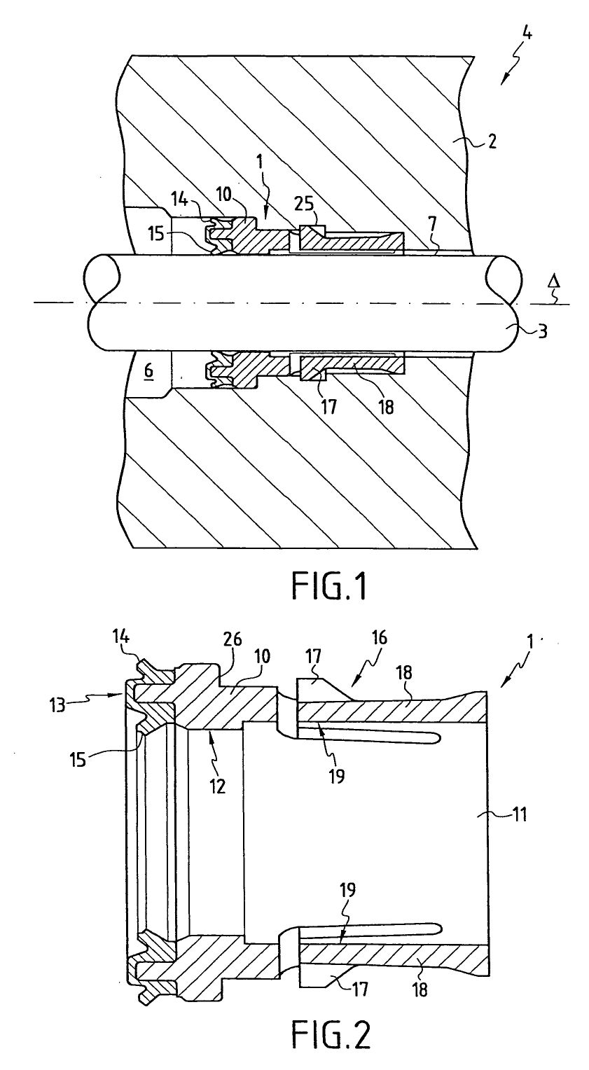

FIG. 1 is an axial section showing a mechanical assembly incorporating a seal unit of the invention.

FIG. 2 is a similar axial section to FIG. 1 showing a larger scale view of the seal unit alone.

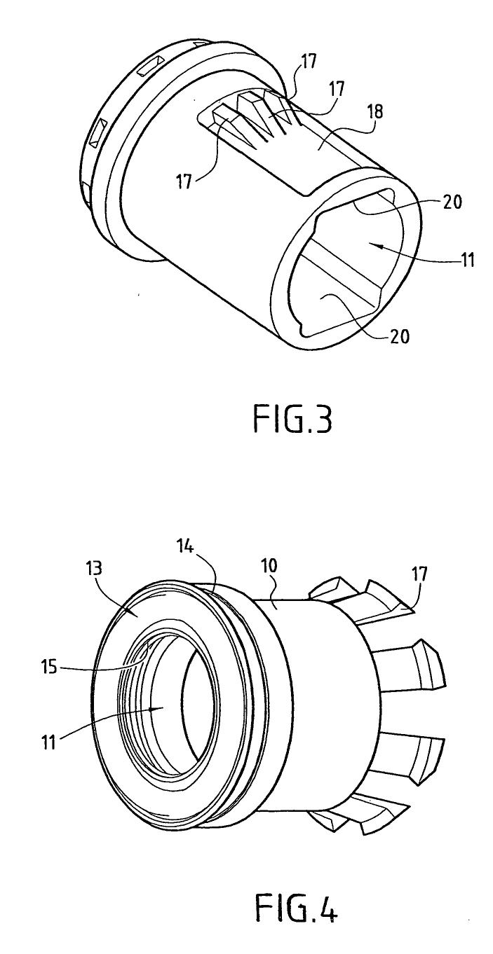

FIG. 3 is a perspective view of the rigid body of the seal unit in FIG. 2.

FIG. 4 is a perspective view of another embodiment of a seal unit according to the invention.

A seal unit of the invention, such as illustrated FIG. 1 and generally designated 1, is intended to be interposed between two mechanical parts 2 and 3 of a mechanical assembly 4, as shown in particular FIG. 2. In the illustrated example, mechanical part 2 forms a body or cylinder inside which mechanical part 3, forming a transmission shaft or piston, is able to move in rotation about its axis Δ and/or in axial translation. Seal unit 1 therefore lies between mechanical parts 2 and 3, ensuring separation of the two chambers 6, 7 located either side of the seal unit 1 and inside which mobile part 3 is able to circulate.

Seal unit 1 of the invention comprises firstly a rigid body 10 intended to ensure the resistance of the entire seal unit 1 and which, in the illustrated example, is of tubular shape defining an axial bore 11 through which mechanical part 3 passes. In preferred but not strictly necessary manner, body 10, inside axial bore 11, has a guiding surface 12 for the passing of part 3, guiding it in rotation and/or in axial translation. To ensure its seal function, part 1 also comprises at least one seal packing 13, exactly one in the illustrated example, that is insert-moulded on body 11. Packing 13 is made so as to have at least one first sealing surface 14 which in the illustrated example is intended to cooperate with the first mechanical part 2 and with respect to which the seal unit is therefore immobile so that the first sealing surface provides a static seal. Seal unit 1 also has at least one second sealing surface 15 intended to cooperate, according to the illustrated example, with the second mechanical part 3 with respect to which seal unit 1 is mobile so that the second sealing surface provides a dynamic seal.

In the above-described illustrated example, the static 14 and dynamic 15 sealing surfaces are each in the shape of a seal lip. However, in the invention, sealing surfaces 14 and 15 could have any other shape such as a single or multiple semi-toroidal shape compatible with their respective static and dynamic seal functions. Similarly, according to the illustrated example, the static 14 and dynamic 15 sealing surfaces are part of the same annular-shaped seal packing 13 insert-moulded at one end of the rigid body 10. However, the static 14 and dynamic 15 sealing surfaces could also belong to two separate packings insert-moulded on the rigid body 10.

To allow immobilisation of seal unit 1 with respect to the first mechanical part 2, according to an essential characteristic of the invention, seal unit 1 comprises connection means 16 with the first mechanical part 2. According to the invention, connection means 16 may be made in any appropriate manner insofar as means 16 are able to ensure the immobilisation function of seal unit 1 with respect to the mechanical part with which it is to ensure a static seal.

In preferred manner, connection means 16 are designed to ensure immobilisation of seal unit 1 on the first mechanical part without having recourse to any added element. In the illustrated example therefore, serving as connection means 16, seal unit 1 comprises two series of three immobilising pins 17 which are each borne by an elastically deformable lug 18 arranged in the rigid body 10. It is to be noted that, in order to avoid any interference between the back 19 of the elastically deformable lugs 18 and mobile part 3, the lugs 18 are located at a recess 20 arranged in the wall of the axial bore 11, as is more clearly shown FIG. 3.

To allow immobilisation of the seal unit 1 when it is engaged in mechanical part 2, the connection means of part 2 intended to cooperate with connection means 16 of seal unit 1 comprise an annular groove 25 in which pins 17 are intended to engage as shown FIG. 2. It is to be noted that to perfect positioning of the seal unit 1 with respect to mechanical part 2, the seal unit 1 also has an outer bearing surface 26 intended to bear upon the first mechanical part 2.

Therefore, through the use of connection means 16 and 25 it is possible to ensure the immobilisation and perfect positioning of seal unit 1 with respect to the first mechanical part 2 and with respect to the second mechanical part 3 that is mobile inside mechanical part 2, without the use of any other mechanical element.

Also, it is to be pointed out that the conformation of connection means 16 such as described above and illustrated FIG. 3, provides perfect protection for the lugs during the different lifetime phases of the seal unit of the invention, namely its fabrication, packaging, transport, mounting in the mechanical assembly and functional use within the operating mechanical assembly.

According to the illustrated example, the connection means of seal unit 1 consist of two series of pins 17 each carried by a lug 18. However, the connection means of the seal unit 1 could be made in any other manner.

For example FIG. 4 illustrates another embodiment of seal unit 1 of the invention. In this other embodiment, the connection means 16 consist of a series of pins or teeth that are elastically deformable and arranged at one end of the rigid body 10, opposite the seal packing, and intended to engage in a groove arranged in mechanical part 2.

According to the previously described and illustrated examples, seal unit 1 is intended to be immobilised with respect to the first mechanical part which can be considered to be immobile, whilst the second mechanical part is mobile inside the first. However, according to the invention, the connection means could be adapted so that seal unit 1 is immobilised with respect to mechanical part 3 so as to be considered mobile with respect to the other mechanical part 2. In this case, the static seal surface is internal and is positioned so as to be in contact with mechanical part 3, whilst the dynamic sealing surface could be considered external so as to be placed in contact with mechanical part 2.

Similarly the connection means of the seal unit of the invention could be formed otherwise. For example, according to the invention, the connection means could be made in the form of a housing intended to receive an added immobilisation part or an immobilisation part forming an integral part of another constituent part of the mechanical assembly in which the seal unit of the invention is used.

Various other modifications may evidently be made to the invention without departing from the scope thereof.

1. Seal unit intended to be interposed between two mechanical parts (2,3) one mobile with respect to the other, a seal unit comprising a rigid body (10) and at least one seal packing (13) insert-moulded on the rigid body (10), so that the seal unit comprises at least one first sealing surface (14) intended to cooperate with a first mechanical part (2) and at least one second sealing surface (15) intended to cooperate with the second mechanical part (3),
characterized in that it comprises connection means (16) with at least one of the mechanical parts (2).

2. Seal unit as in claim 1, characterized in that the connection means (16) ensure immobilisation of the seal unit with respect to the first mechanical part.

3. Seal unit as in claim 1, characterized in that the connection means (16) are integral with the rigid body (10).

4. Seal unit as in claim 3, characterized in that the connection means (16) comprise at least one pin (17) intended to engage in a complementary housing (25) offered by the first mechanical part (2).

5. Seal unit as in claim 4, characterized in that the pin is borne by at least one lug (18) elastically deformable and integral with the rigid body (10).

6. Seal unit as in claim 1, characterized in that the body (10) is of tubular shape and defines a through bore (11) for the passage of the second mechanical part (3), whilst the seal packing (13) is of substantially annular shape.

7. Seal unit as in claim 6, characterized in that the bore (11) of body (10) comprises at least one bearing surface (12) guiding the second mechanical part (3) in translation and/or rotation.

8. Seal unit as in claim 5, characterized in that the lug (18) is arranged at a recess (20) made in the wall of the bore (11) passing through the body (10).

9. Seal unit as in claim 1, characterized in that the body (10) comprises at least one static guiding surface (26) intended to ensure positioning of the seal unit (1) with respect to the first mechanical part (2).

10. Seal unit as in claim 1, characterized in that the rigid body (10) is made in plastic material.

11. Mechanical assembly comprising two mechanical parts (2,3) one mobile with respect to the other, and a seal unit (1) as in claim 1,
characterized in that the mechanical part (2) comprises connection means (25) intended to cooperate with the connection means (16)) of the seal unit (1).

12. Mechanical assembly as in claim 11, characterized in that the first part (2) comprises at least one chamber (6,7) inside which the second part (3) is mobile in translation and/or in rotation.

13. Mechanical assembly as in claim 12, characterized in that the first mechanical part (2), as connection means (15) with the seal unit (1), comprises an annular groove arranged in the passage chamber (7) of the second part (2).

14. Seal unit as in claim 7, characterized in that the lug (18) is arranged at a recess (20) made in the wall of the bore (11) passing through the body (10).
